(19) United States
(12) Patent Application Publication
(10) Pub. No.: US 2005/0044548 A1
(43) Pub. Date: Feb. 24, 2005

(54) Efficient replication of embedded operating system with a write filter and overlay partition

(76) Inventor: John Page, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/644,011

(22) Filed: Aug. 20, 2003

(51) Int. Cl. G06F 9/00

(52) U.S. Cl. 718/100

(57) ABSTRACT

The specification relates to a process of cloning a master embedded system configured with a non-writable volume or partition that stores an embedded operating system, where the master system is configured to provide an overlay to store updates directed to the non-writable volume or partition. A flag in the master system is configured with a setting, where the configured flag is for indicating that the overlay is needed and has not been provided. After configuring the flag, a master image of the master system is created, where the master image includes the configured flag. A clone of the master system is created on a storage of another system based on the master image. Storage units may store images created with the process. Storage units may also store cloned systems produced with the images. A clone of the master system may be provided with an overlay based on the setting of the flag in the clone of the master system, where the overlay provides file-system level write functionality to the non-writable volume or partition of the clone system.

### BACKGROUND OF THE INVENTION

1. Field of the Invention

The present invention is directed to the field of cloning operating systems, and more specifically, to the field of imaging or replicating embedded operating systems that include an overlay or write filter partition.

2. Description of the Related Art

An operating system manages and makes available the resources of a computer. Some operating systems, such as Windows XP, have an embedded version with special features to improve reliability, mass deployment, ease of administration, etc. For example, because an embedded operating system may be intended to run on a minimal hardware platform, one feature is that unnecessary operating system components may be omitted to reduce its production size. Also, because embedded operating systems are sometimes used on computers that require reliable low-maintenance operation, the embedded system may be protected or kept in its originally configured state by storing it on a read-only partition or storage medium.

For flexibility, an overlay is sometimes provided or configured to keep changes to the embedded system separate from the original installation of the system; the original installation stays constant. This makes it possible to easily restore or reset the system if it becomes corrupt. Any corruption will be on the overlay, and the overlay can be deleted or flushed to reset the system to its original state.

FIG. 1 shows an example of a prior art system using a write filter 50 and overlay partition 52. The write filter 50 in FIG. 1 protects or allows apparent writing to the contents of non-writable or write protected partition or volume 54. Writes that are directed to the target media or protected volume 54 are redirected by the write filter 50 to the overlay partition 52. The data stored on the overlay partition 52 is provided by the write filter 50 when needed for a file system read. Used in this context, an overlay is similar to a transparency overlay on an overhead projector. Any change made to the overlay affects the observed combined picture, but if the overlay is removed, the underlying picture remains unchanged. In other words, the write filter 50 filters updates directed to a protected volume or partition 54 and redirects them to the special overlay partition 52. This allows the operating system to boot from read-only media such as CD-ROMs, write-protected hard disks, or flash media. The overlay partition serves as a form of persistent cache and gives the appearance that the corresponding protected volume is writeable. The embedded system may sometimes be configured to allow the overlay partition 52 to be committed to the partition 54 of the embedded system.

More detailed discussion of an embedded operating system and an overlay for the same may be found in “Windows XP Embedded Step by Step”, by, James Beau Cseri, published by RTC Books in March 2003 (ISBN 0929392736), which is incorporated herein by reference.

System imaging is a known process for reproducing, often en masse, a master computer system such as a production-configured embedded operating system. An image of a preconfigured master system is created. The image is then used as a source to clone the master system. Clones of the master system are created and initially mirror the master system. It is often necessary or desirable to create a master image of an embedded system that includes an overlay, or where an overlay is desired in the clones created with the image. However this has not been previously possible using standard imaging tools. What is needed is a method of efficiently imaging a system with an overlay, which typically comprises a write filter and an overlay partition.

### SUMMARY OF THE INVENTION

It is an aspect of the present invention to provide a method of imaging an embedded system that does not require manual creation of a writable overlay.

It is another aspect of the present invention to provide a method of automatically creating an image of a master embedded system where a clone of the image automatically creates its own overlay partition.

It is yet another aspect of the present invention to provide a method or system that may be used to clone a master system using imaging tools, where clones of the master system self-create overlays when booted.

It is still another aspect of the present invention to provide a method for imaging a system with a write filter that does not require bit-by-bit copying of a complete hard disk found in the system being imaged

It is another aspect of the present invention to provide a compressed system image that is decompressed with an imaging tool and that is enabled to self-create a write filter and overlay partition when booted.

It is a further aspect of the present invention to produce system images enabled for overlays that are not limited to being installed on a given disk size or configuration.

The above aspects can be attained by a system or process for cloning a master embedded system configured with a non-writable volume or partition that stores an embedded operating system, where the master system is configured to provide an overlay to store updates directed to the non-writable volume or partition. A flag in the master system is configured with a setting, where the configured flag is for indicating that the overlay is needed and has not been provided. After configuring the flag, a master image of the master system is created, preferably with a compressing imaging tool, where the master image includes the configured flag. A clone of the master system is created on a storage of another system based on the master image. Storage units may store images created with the process. Storage units may also store cloned systems produced with the images. A clone of the master system may be provided with an overlay based on the setting of the flag in the clone of the master system, where the overlay provides file-system level write functionality to the non-writable volume or partition of the clone system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows an example of a prior art system using a write filter 50 and overlay partition 52.

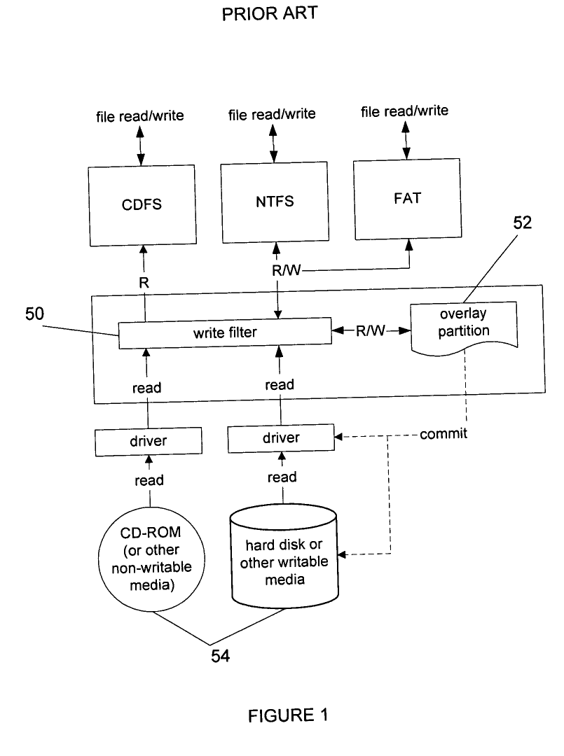

FIG. 2 shows a process for creating an image.

FIG. 3 shows hardware of the present invention.

### DETAILED DESCRIPTION OF THE PREFERRED EMBODIMENTS

As mentioned in the Background, when manufacturing computer systems (e.g. duplicating an embedded system), it is known to create a single image of the operating system and replicate it onto the hard drives or storage units of multiple and often identical computers. System imaging saves time and prevents errors that would occur with multiple individual installations. Two previous approaches to system imaging were to exactly copy, bit-for-bit, the master system, or to use an imaging tool to create a compressed or condensed image. However, with the first approach, the created image can only be installed onto a hard drive with the same size and configuration of the master's hard drive. Furthermore, images created with the bit-by-bit imaging approach are large and take a long time to create. Their size can make them impractical for network-based image installs.

The second approach of using an imaging tool is preferable to the bit-by-bit approach because imaging tools create a compressed or condensed image, which may be installed in much less time than a bit-for-bit mirror image and which may be installed on any size or configuration of hard drive. For example, an imaging tool might ignore free disk space in a master partition. When installing from the image, the imaging tool explodes the condensed image to the destination clone system. PowerQuest DriveImage and Paragon Drive Backup are examples of tools that may be used to clone or image a master or source system. Imaging tools have not been feasible when an overlay is needed in the clone systems. These kinds of tools typically scan the disk drive of the master system to look for partitions of standard types, such as the NT File System (NTFS) partition type or the File Allocation Table (FAT) partition type. These imaging tools typically compress those partitions into a small image package, for example a ZIP file. There may also be logical compression that identifies and omits unnecessary components. Such compressed images are usually conveniently stored on a network where clones based on the image are being produced. Such an image may then be used to produce clones of the master system.

There is a problem with image cloning tools. Cloning tools are not able to recognize non-standard types of partitions. Cloning tools tend to ignore non-standard types of partitions and do not include them in the produced compressed image. Windows XP Embedded (XPE), for example, uses a non-standard partition type for the overlay partition that stores filtered data. Thus, when the write filter is included as part of the operating system it cannot be accurately replicated to multiple hard drives using software imaging tools. Only the bit-by-bit copy has been able to duplicate an overlay partition, but has the limitations discussed above.

It is noted that there has been a need in the field of high volume system production to create a condensed image of Windows XPE having an overlay by using standard imaging tools. Many system administrators have been frustrated in their attempts, and despite significant effort, no satisfactory workarounds have been previously discovered. Other attempts, usually manual, have fallen short in the result and have not achieved mass duplication. Even a concerted effort on the part of the Microsoft Corporation failed to find any solution and recommended the unacceptable approach of using bit-by-bit copying. An aspect of the present invention allows existing standard imaging tools (or future imaging tools) to be used to replicate an operating system such as Windows XPE when it has a write filter and overlay partition while preserving all of the advantages of tool-based system replication. The technique discussed below, although simple in practice, is highly reliable and efficient, and does not significantly increase the size of the produced image.

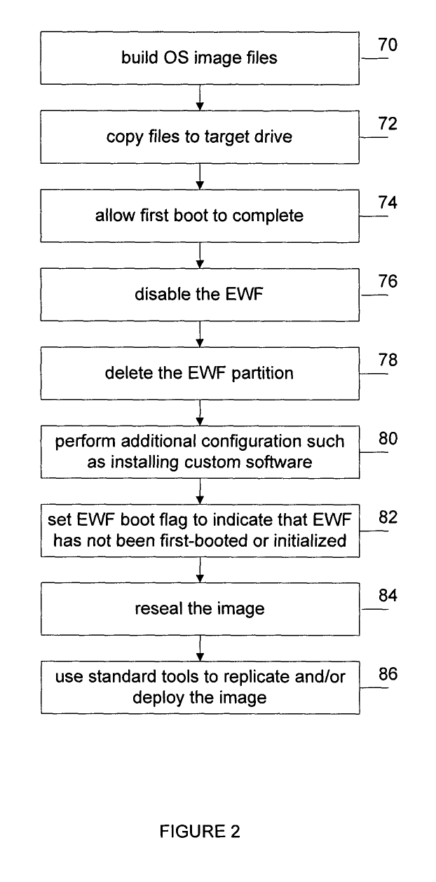

FIG. 2 shows a process for creating an image. First, the operating system image files are built 70 with the write filter enabled. Any components and flags needed for initializing and running the write filter are included (for example dynamically loaded libraries used by the write filter). Next, the operating system is copied 72 to the target drive to be imaged. Then the master system completes 74 a first boot. The write filter is disabled 76 and the write filter's overlay partition is preferably deleted 78. In the case of Windows XPE, the filter may be disabled 76 by “ewfmgr c: -disable”, and then rebooting. The overlay partition may be deleted 78 with Windows XPE's Disk Management.

After these steps, any additional configuration or software that is to be part of the embedded system is installed 80. Then, a flag used for indicating whether the write filter has been initialized is set 82 to zero (e.g. false). Setting 82 the flag essentially tells or indicates to the system: “the write filter partition for this system has not been created”. For example, in Windows XPE, the flag or registry subkey has typically been “HKEY_Local_Machine\System\CurrentControlSet\Control\WindowsEmbedded\FBA\42939191 XX”, where XX varies (FBA stands for First Boot Agent). This subkey contains an “FBAWasHere” flag or value. Although the registry is subject to change with new operating system releases, the correct registry entry can be recognized by its Parameters key, which references “ewfdll.dll”. After setting 82 the “FBAWasHere” flag to zero, the system is resealed 84, for example by running “fbreseal.exe”. At this point, the master image is enabled to self-create the write filter and partition. Because that flag has been set 82 to zero, the operating system will, on the first boot after resealing 84, consider the flag and understand that the write filter and its overlay partition require initialization and creation. Standard tools may be used 84 to replicate and deploy the image. Finally, the master system may be imaged and/or deployed 86 using standard imaging tools.

Resealing 84 is a process by which a system is logically reset, at least partially, to a state of not having been booted. Resealing sets a reseal flag in the system that indicates that the system has been resealed and causes the system when booted to go through several first-boot items, discussed below. Resealing 84 the master system naturally causes the clones or copies of the master system to also be in a resealed state. The resealing 84 allows a clone of a master image to initialize some system parameters with settings different than the master image. Typically, registry entries are set. Resealing 84 typically is used to cause the clone system to set its own unique System ID (SID), network parameters, etc. when the clone machine is first-booted. More specifically, with Windows XPE, when the master image (and therefore its unbooted clone copy) has been resealed, the operating system is enabled to recognize that it needs to run a small abbreviated First Boot Agent (FBA) when the system first boots after the resealing 84. Among other things, the abbreviated FBA checks the “FBAWasHere” flag. When it sees that the flag or registry entry is zero, it causes the write filter to become active and it causes the overlay partition to be formatted. Thus, it may be said that the master image (or clones thereof), produced as discussed above, and before having been first-booted (or before having been booted after being resealed), is enabled to or configured to self-create the overlay.

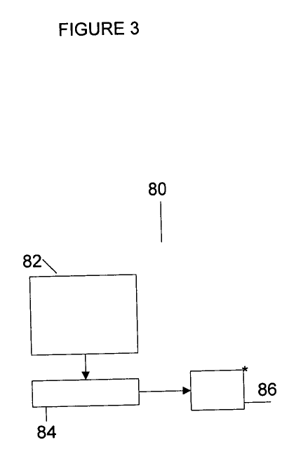

FIG. 3 shows hardware of the present invention. Masters and clones of the present invention may be implemented with a system 80, such as depicted in FIG. 3, which may include a display 82. Many embedded systems are rack mounted and will not have a display 82. A master system will usually have a display 82. A computer or CPU 84 performs the processes described herein and an input device 86, such as a mouse or stylus with pad, is used for control. The system 80 also includes storage (not shown), such as disc storage and RAM in which the processes and images of the present invention can be stored and on which the processes can be distributed. The processes can also be distributed via a network, such as the Internet.

The present invention has been described with respect to a system or process for cloning a master embedded system configured with a non-writable volume or partition that stores an embedded operating system, where the master system is configured to provide an overlay to store updates directed to the non-writable volume or partition. A flag in the master system is configured with a setting, where the configured flag is for indicating that the overlay is needed and has not been provided. After configuring the flag, a master image of the master system is created, preferably with a compressing imaging tool, where the master image includes the configured flag. A clone of the master system is created on a storage of another system based on the master image. Storage units may store images created with the process. Storage units may also store cloned systems produced with the images. A clone of the master system may be provided with an overlay based on the setting of the flag in the clone of the master system, where the overlay provides file-system level write functionality to the non-writable volume or partition of the clone system.

In the embodiment discussed above, the code or software that creates the overlay partition is provided as a part of the embedded operating system. The overlay code creates the overlay partition based on the write filter registry flag during the first boot. However, it is also possible that the operating system code may be supplanted by custom written code included with the master image. The custom code can be written to format or create the overlay. In this case, the creation of the overlay could be flagged or driven by its non-existence during booting.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method of cloning a master system, the method comprising:
enabling an image of the master system, that includes a non-writable file partition, to automatically self-create an overlay that receives writes directed to the file partition, where the non-writable file partition comprises an operating system.

2. A method according to claim 1, wherein the image comprises code to automatically create the overlay based on the absence of an overlay partition in the image.

3. A method according to claim 1, wherein the image is configured to perform the automatic self-creating when the image is booted.

4. A method according to claim 3, wherein the image comprises a flag that indicates that the overlay has not been created, and wherein the automatic self-creating occurs in response to recognition of the flag when the image is booted.

5. A method according to claim 1, wherein the operating system is an embedded operating system.

6. A method according to claim 5, wherein the embedded operating system is a Microsoft Windows embedded operating system.

7. A method according to claim 1, wherein the operating system comprises a file system module that makes the non-writable file partition available as a writable file system, and where the overlay and embedded write filter function together in the operating system as a layer between the file system module and one or more storage media that store the data of the non-writable file partition and the data of the overlay, whereby the combined data so stored is transparently made available through the file system module as the writable file system.

8. A method according to claim 7, wherein the image comprises a flag that indicates that the overlay has not been created, and wherein the automatic self-creating occurs in response to recognition of the flag when the image is booted.

9. A method according to claim 7, wherein the file system module implements a standard file system type, and wherein the overlay has a nonstandard file system type.

10. A method according to claim 9, wherein the overlay's nonstandard file system type renders it unrecognizable by cloning tools that can recognize and clone the standard file system type.

11. A machine readable storage storing the image according to claim 1.

12. A method of cloning a master system configured with a non-writable volume or partition comprising an operating system, where the master system is configured to provide an overlay to store updates directed to the non-writable volume or partition, the method comprising:
configuring a flag in the master system with a setting, where the configured flag is for indicating that the overlay is needed and has not been provided;
after configuring the flag, creating a master image of the master system, where the master image includes the configured flag; and
creating a clone of the master system on a storage of another system based on the master image.

13. A method according to claim 12, further comprising automatically providing the clone of the master system with an overlay based on the setting of the flag in the clone of the master system, where the overlay provides file-system level write functionality to the non-writable volume or partition of the clone system.

14. The storage according to claim 13, the storage storing the clone of the master system that was automatically provided with the overlay.

15. The storage according to claim 12, the storage storing the clone of the master system.

16. A method, comprising:
building an operating system install comprising operating system files on a target drive, where the operating system install is configured to have an overlay providing write capability to a non-writable partition; then
performing a first boot of the target drive;
disabling the overlay; and
configuring the operating system install to have both a resealed or logical first-boot state and to indicate that the overlay is needed and has not been initialized.

17. A method according to claim 16, further comprising creating a condensed image of the operating system using an imaging tool, where the condensed image is capable of being installed on disk drives with different sizes or configurations.

18. A storage storing a condensed system image comprising an operating system, where the condensed system image is capable of being exploded to install the operating system on disk drives with different sizes or configurations, and where the operating system is enabled to self-create an overlay partition and write filter when booted.

19. An apparatus for cloning a master system configured with a non-writable volume or partition comprising an operating system, where the master system is configured to provide an overlay to store updates directed to the non-writable volume or partition, the apparatus comprising:
a flag in the master system configured with a setting, where the configured flag is for indicating that the overlay is needed and has not been provided;
a master image of the master system, created after the flag is configured, where the master image includes the configured flag; and
a clone of the master system created on a storage of another system based on the master image.
